(19) United States
(12) Patent Application Publication
(10) Pub. No.: US 2011/0097118 A1
(43) Pub. Date: Apr. 28, 2011

(54) ADVANCED PRINTING SYSTEM EMPLOYING NON-CONVENTIONAL TONERS AND GANGED PRINTERS

(76) Inventors: Young No, Pittsford, NY (US); Donna P. Suchy, Rochester, NY (US); Joseph A. Manico, Rochester, NY (US)

(21) Appl. No.: 12/607,130

(22) Filed: Oct. 28, 2009

(51) Int. Cl. G03G 15/01; G06K 15/02

(52) U.S. Cl. 399/301; 358/3.28

(57) ABSTRACT

A system and method using an electrographic printer for printing of a print including an image and a particular pattern using techniques that also allows the selective application of non-conventional toners to an image formed on a printed media using registration marks to locate the original image on the printed media in order to provide proper alignment of the non-conventional toner image to the original printed image. The system employs two printers, the first is a conventional EP printer with the capability (internal or via driver software) to place registration marks on the print media along with the printed image, and a second printer adapted to read the registration marks on the printed media. Once the registration marks are read the non-conventional toner image is applied by the second printer in relative relation the positions of the read registration marks.

### FIELD OF THE INVENTION

The present invention relates electrographic printing and more particularly to printing a specialty item electrographically.

### BACKGROUND OF THE INVENTION

One common method for printing images on a receiver member is referred to as electrography. In this method, an electrostatic image is formed on a dielectric member by uniformly charging the dielectric member and then discharging selected areas of the uniform charge to yield an image-wise electrostatic charge pattern. Such discharge is typically accomplished by exposing the uniformly charged dielectric member to actinic radiation provided by selectively activating particular light sources in an LED array or a laser device directed at the dielectric member. After the image-wise charge pattern is formed, the pigmented (or in some instances, non-pigmented) marking particles are given a charge, substantially opposite the charge pattern on the dielectric member and brought into the vicinity of the dielectric member so as to be attracted to the image-wise charge pattern to develop such pattern into a visible image.

Thereafter, a suitable receiver member (e.g., a cut sheet of plain bond paper) is brought into juxtaposition with the marking particle developed image-wise charge pattern on the dielectric member. A suitable electric field is applied to transfer the marking particles to the receiver member in the image-wise pattern to form the desired print image on the receiver member. The receiver member is then removed from its operative association with the dielectric member and the marking particle print image is permanently fixed to the receiver member typically using heat, and/or pressure and heat. Multiple layers or marking materials can be overlaid on one receiver, for example, layers of different color particles can be overlaid on one receiver member to form a multi-color print image on the receiver member after fixing or a variable pattern having variations due to material lay down.

There is a need for specialty items that are digitally prepared and include additional layers of non-conventional materials such as unconventional toner. This has not been successful because the printing of unconventional materials requires a separate pass or separate application, such as a specialized printer that can print on the preprinted receiver, often with a preprinted image and this causes registration problems. This invention solves this problem by creating digitally printed patterns that can be used to create a registration object these specialty items as described below but which are not visible to the customer.

### SUMMARY OF THE INVENTION

The printing method for producing a print including an image and a particular pattern using techniques that also allows the selective application of non-conventional toners to an image formed on a printed media using registration marks to locate the original image on the printed media in order to provide proper alignment of the non-conventional toner image to the original printed image. The system employs two printers, the first is a conventional EP printer with the capability (internal or via driver software) to place registration marks on the print media along with the printed image, and a second printer adapted to read the registration marks on the printed media. Once the registration marks are read the non-conventional toner image is applied by the second printer in relative relation the positions of the read registration marks.

The invention, and its objects and advantages, will become more apparent in the detailed description presented below.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures.

In the detailed description of the preferred embodiment of the invention presented below, reference is made to the accompanying drawings, in which:

FIG. 1 is a schematic side elevational view, in cross section, of a typical electrographic reproduction apparatus suitable for use with this invention.

FIG. 2 is a schematic side elevational view, in cross section, of the reprographic image-producing portion of the electrographic reproduction apparatus of FIG. 1, on an enlarged scale.

FIG. 3 is a schematic side elevational view, in cross section, of one printing module of the electrographic reproduction apparatus of FIG. 1, on an enlarged scale.

FIG. 4 is an embodiment of a method printing suitable to manufacture digitally prepared specialty items using registration pattern produced by the invention.

FIG. 5 is one embodiment of a schematic of a portion of the invention of FIG. 1 that prints non-conventional material.

FIG. 6 is an embodiment of a method printing suitable to manufacture digitally prepared specialty items.

FIGS. 7a, 7b, and 7c show registration marks produced by the method of the present invention.

### DETAILED DESCRIPTION OF THE INVENTION

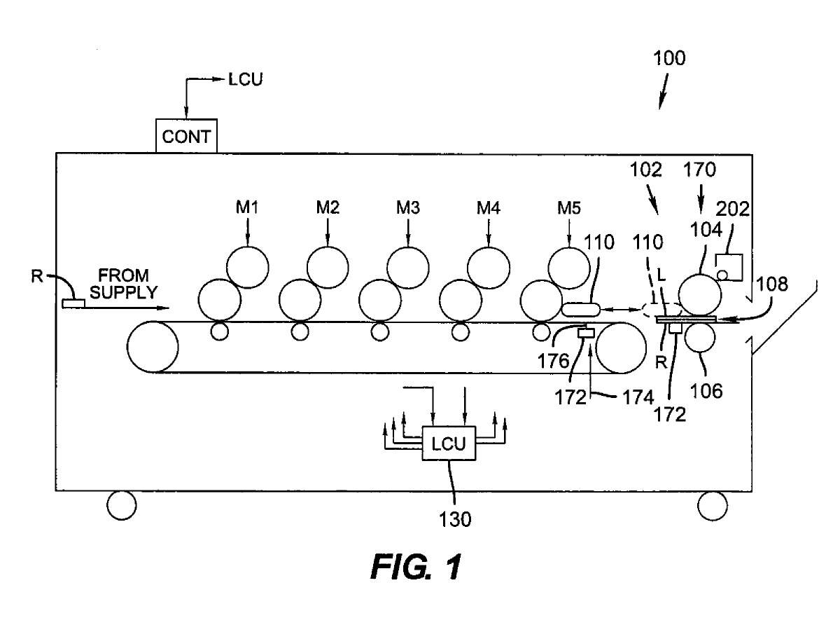

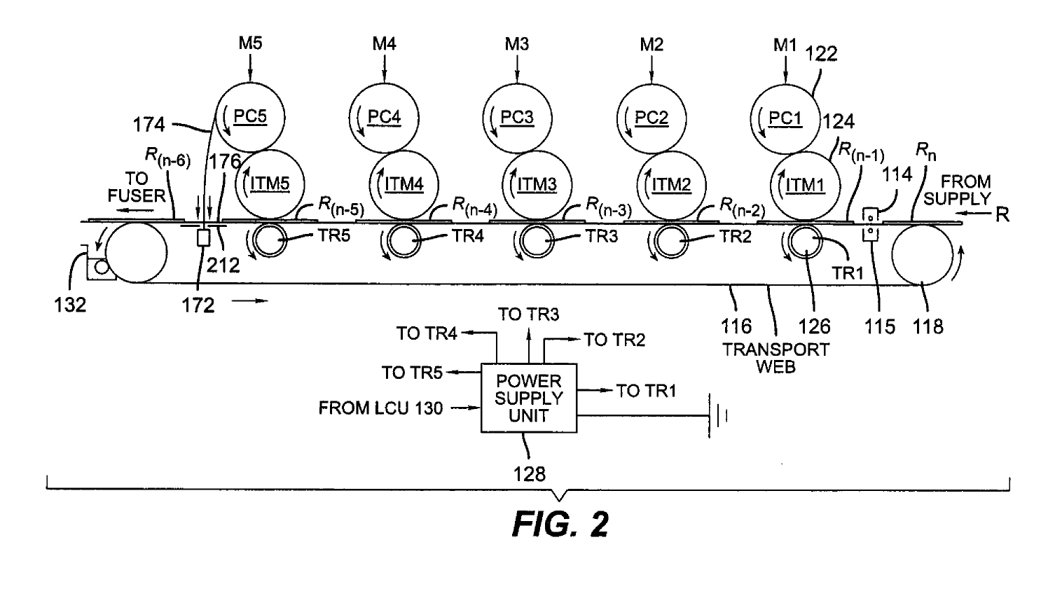

Referring now to the accompanying drawings, FIGS. 1 and 2 are side elevational views schematically showing portions of a typical electrographic print engine or printer apparatus suitable for printing of non-conventional materials on one or more prints. One embodiment of the invention involves printing using an electrophotographic engine having five sets of single layer image producing or printing stations or modules arranged in tandem and an optional finishing assembly. The invention contemplates that more or less than five stations may be combined to deposit a material, such as toner, on a single receiver member, or may include other typical electrographic writers, printer apparatus, or other finishing devices.

In one embodiment, an electrographic printer apparatus 100 has a number of tandemly arranged electrostatographic image forming printing modules M1, M2, M3, M4, and M5 and a finishing assembly 102. Additional modules may be provided. applications such as projection assemblies. One example is an Eastman Chemical polyester-based resin sheet, Lenstar™, specifically designed for the lenticular market. Also thermosetting plastics could be used, such as the thermosetting polyester beads prepared in a PVA1 stabilized suspension polymerization system from a commercial unsaturated polyester resin at the Israel Institute of Technology.

The toner used to form the predetermined registration pattern in one embodiment uses one or more of the above described toner and/or another toner which can be MICR, raised, clear, or a color. It is usually preferred to have a closely controlled pattern that is easy to read and interpret by a registration reader. In this one embodiment various attributes make the use of a light colored toner, such as yellow toner, a good toner to use. If the pattern is raised then it also needs to have a closely controlled size and final lay-down height as described in co-owned US2008/159786. This can be achieved through the grinding and treating of toner particles to produce various resultants sizes. This is difficult to do for the smaller particular sizes and tighter size distributions since there are a number of fines produced that must be separated out. This results in either poor distributions and/or very expensive and poorly controlled processes. An alternative is to use a limited coalescence and/or evaporative limited coalescence techniques that can control the size through stabilizing particles, such as silicon. These particles are referred to as chemically prepared dry ink (CDI) below. Some of these limited coalescence techniques are described in patents pertaining to the preparation of electrostatic toner particles because such techniques typically result in the formation of toner particles having a substantially uniform size and uniform size distribution.

Representative limited coalescence processes employed in toner preparation are described in U.S. Pat. No. 4,965,131, which is hereby incorporated by reference. In one example a pico high viscosity toner, of the type described above, could form the first and or second layers and the top layer could be a laminate or an 8 micron clear toner in the fifth station thus the highly viscous toner would not fuse at the same temperature as the other toner. In the limited coalescence techniques described, the judicious selection of toner additives such as one belt for all photoconductors. Also other printers that do not use photoconductors, such as inkjet printers could use a similar registration method and the method encompasses all these types of printers as applicable.

A receiver member, Rn, arriving from the supply, is shown passing over roller 118 for subsequent entry into the transfer station of the first printing module, M1, in which the preceding receiver member R(n−i) is shown. Similarly, receiver members R n−2) R(n)) R(n−4), and R<n−5) are shown moving respectively through the transfer stations of printing modules M2, M3, M4, and M5. An unfused image formed on receiver member R (n−6) is moving, as shown, towards one or more finishing assemblies 118 including a fuser, such as those of well known construction, and/or other finishing assemblies in parallel or in series that includes, preferably a lamination device 110 (shown in FIG. 1). Alternatively the lamination device 110 can be included in conjunction to one of the print modules, Mn, which in one embodiment is the fifth module M5.

A power supply unit 128 provides individual transfer currents to the transfer backup rollers TR1, TR2, TR3, TR4, and TR5 respectively. A logic and control unit 130 (FIG. 1) in response to signals from various sensors associated with the electrophotographic printer apparatus 100 provides timing and control signals to the respective components to provide control of the various components and process control parameters of the apparatus in accordance with well understood and known employments. A cleaning station 132 for transport web 116 is also typically provided to allow continued reuse thereof.

The toner used to form the first print 153 can be styrenic (styrene butyl acrylate) type used in toner with a polyester toner binder. Typically the polymer used is a toner resin having a density 1.53 to almost 1.6. These are the typical measurements of the polyester toner binder, as well as styrenic (styrene butyl acrylate) toner. Typically the polyesters are around 1.54 and the styrenic resins are 1.59. The conditions under which it was measured (by methods known to those skilled in the art) are at room temperature and about 590 nm. One skilled in the art would understand that other similar materials could also be used. These could include both thermoplastics such as the polyester types and the styrene acrylate types as well as PVC and polycarbonates, especially in high temperature applications such as projection assemblies. One example is an Eastman Chemical polyester-based resin sheet, Lenstar™, specifically designed for the lenticular market. Also thermosetting plastics could be used, such as the thermosetting polyester beads prepared in a PVA1 stabilized suspension polymerization system from a commercial unsaturated polyester resin at the Israel Institute of Technology.

The toner used to form the predetermined registration pattern in one embodiment uses one or more of the above described toner and/or another toner which can be MICR, raised, clear, or a color. It is usually preferred to have a closely controlled pattern that is easy to read and interpret by a registration reader. In this one embodiment various attributes make the use of a light colored toner, such as yellow toner, a good toner to use. If the pattern is raised then it also needs to have a closely controlled size and final lay-down height as described in co-owned US2008/159786. This can be achieved through the grinding and treating of toner particles to produce various resultants sizes. This is difficult to do for the smaller particular sizes and tighter size distributions since there are a number of fines produced that must be separated out. This results in either poor distributions and/or very expensive and poorly controlled processes. An alternative is to use a limited coalescence and/or evaporative limited coalescence techniques that can control the size through stabilizing particles, such as silicon. These particles are referred to as chemically prepared dry ink (CDI) below. Some of these limited coalescence techniques are described in patents pertaining to the preparation of electrostatic toner particles because such techniques typically result in the formation of toner particles having a substantially uniform size and uniform size distribution.

Representative limited coalescence processes employed in toner preparation are described in U.S. Pat. No. 4,965,131, which is hereby incorporated by reference. In one example a pico high viscosity toner, of the type described above, could form the first and or second layers and the top layer could be a laminate or an 8 micron clear toner in the fifth station thus the highly viscous toner would not fuse at the same temperature as the other toner. In the limited coalescence techniques described, the judicious selection of toner additives such as charge control agents and pigments permits control of the surface roughness of toner particles by taking advantage of the aqueous organic interphase present. It is important to take into account that any toner additive employed for this purpose that is highly surface active or hydrophilic in nature may also be present at the surface of the toner particles.

When the registration pattern is to be a raised image the toner particle size for raised patterns is important to be controlled since larger particles not only result in the desired heights and registration patterns. Similarly when a variable gloss image is to be used that is created using a variable viscosity toner, a toner viscosity needs to be measured, for example by a Mooney viscometer, a meter that measures viscosity, since the higher viscosities will help create a variable gloss registration pattern and will also result in a retained form over a longer period of time. Note that it is possible that a non-visible registration mark may be detectable in other ways, such as by feel or gloss detection or even the use of a microscope but would not be considered obviously visible so is essentially not noticeable, thus not visible, to the customer.

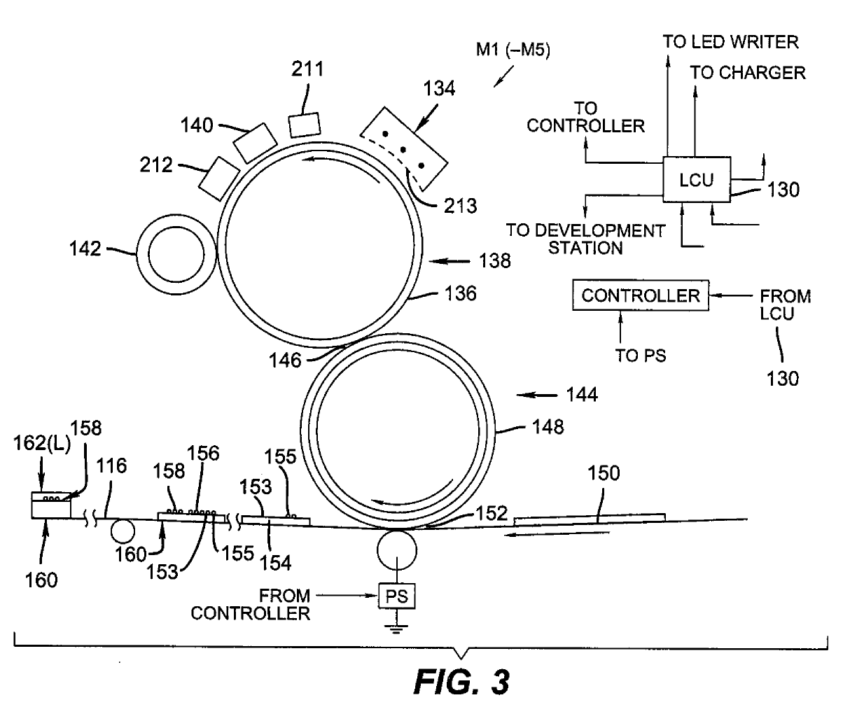

With reference to FIG. 3 wherein a representative printing module (e.g., M1 of M1-M5) is shown, each printing module of the electrographic printer apparatus 100 includes a plurality of electrographic imaging subsystems for producing one or more multilayered image or registration pattern. A non conventional toner 156 is applied to a pre-printed image 153 on receiver member 154 which can be preprinted media, using registration patterns 155 on the receiver 154. These non-conventional toners can be applied relative to the registration marks in; image-wise patterns reverse image-wise patterns, ancillary patterns in relative positions to the original printed image, or as a flood coat.

The non conventional toner 156 can include one or more of a clear toner, a MICR toner, extended gamut toners, metallic toners, a clear, dimensional clear, metallic, pearlescent, large particle, extended color gamut, adhesive, MICR, texture enhancing, gloss, and matte including materials referred to as toner, powder, plastics, glass, solids such as metals and inks. The non-conventional toners are printed by the same printer or on a separate printer. The registration pattern(s) 155 to be used for registration of the non-conventional material to the receiver member 154 can include the use during printing of a yellow toner, such as by incorporating the yellow toner in a different colored background.

The registration pattern can also use a clear raised toner as described in U.S. Pat. No. 7,212,772 and co-owned U.S. published application 2008/159786 which are hereby incorporated by reference. The entire image or a printing the image could also be used as the registration pattern according to this invention. The registration pattern 155 could also include one or more micro print, that is alone or part of a pattern. Similarly, the pattern 155 can be a mask, such as a shadow mask or optionally an interaction pattern, as a Fresnel lens would produce, due to two types of toner or an interaction due to the original image 153 and the non-conventional material, such as a clear raised toner 156 that interact to form a pattern that serves also as a registration pattern 155. The pattern can also involve texturing as described in co-owned U.S. Pat. Nos. 7,212,772, 7,324,240 and 7,468,820 which are hereby incorporated by reference.

Included in each printing module is a primary charging subsystem 134 for uniformly electrostatically charging a surface 136 of a photoconductive imaging member (shown in the form of an imaging cylinder 138). An exposure subsystem 140 is provided for image-wise modulating the uniform electrostatic charge by exposing the photoconductive imaging member to form a latent electrostatic multi-layer (separation) image of the respective layers. A development station subsystem 142 helps develop the image-wise exposed photoconductive imaging member. An intermediate transfer member 144 is provided for transferring the respective layer (separation) image from the photoconductive imaging member through a transfer nip 146 to the surface 148 of the intermediate transfer member 144 and from the intermediate transfer member 144 to a receiver member (receiver member 150 shown prior to entry into the transfer nip 152 and receiver member 154 shown subsequent to transfer of an image 153 before the receiver receives the non-conventional materials, such as toner, 156 as one or more images in superposition to form a final printed specialty item, such as a final print 160 that includes a registered composite image 158 that can be produced on the same printer after a second or additional pass through the same printer.

The printer that applies the non-conventional materials can be the same printer or a second device, such as the first printer, and can be used in a similar manner to the first printer that also added the registration marks, as described above. The second printer would also have a registration reading means, such as a registration reading device, and a means to print the non-conventional toners on the printed media, relative to the positions of read registration marks. For example a second EP printer would print in a manner similar to the first and use multiple, usually 4-5 toner cartridges. During the second print pass of the same printer, or during a second separate pass through a similar EP printer, individual toner cartridges that would contain the non-conventional toners that would be used independently. These could include toners such as clear toner and MICR toner or collaboratively such as extended gamut C, M, Y, K toners. These printers can be connected physically, connected via wirelessly/wired, for in-line paper handling. Alternatively be off-line, such as a wireless/or connection that supplies one or more images to be printed. If there is a wireless connection, in one embodiment, a multipage job is received by the printer via a wireless connection and the registration marks described above are used both to register the images and to supply additional information that controls what information is printed on which page so that they can be printed on any machine (one or multiple printer machines) in any sequence that makes the system most efficient. For example, a stacked sequence could be used that would print 1 out of 10, 2 out of 10, etc. The registration marks are digitally changed so each unique registration mark represents that image on that page, such as a modified UPC code. This way when each page has different treatments, such as a differential gloss or raised print that treatment is properly applied using only the registration mark, no other coded information is necessary and by adding the additional information to one or more patterns the printer controller can control what information is printed on a page thus enabling printing of that page on any printer, in any sequence.

The final item including the composite image 158, 160 is also shown subsequent to a transfer of an additional layer 162 that can be, in one embodiment, on a separate device, such as a separate printer and can produce the registered composite image 158 in a separate printer only or in conjunction with the printer described. That is the registered specialty item does not have to have the non-conventional material applied with a printer at all but could use an alternative device, such as a laminator and the above steps would all occur on that device subsequent to transfer of an image 153.

The logic and control unit (LCU) 130 shown in FIG. 3 includes a microprocessor incorporating suitable look-up tables and control software, which is executable by the LCU 130. The control software is preferably stored in memory associated with the LCU 130. Sensors associated with the fusing assembly provide appropriate signals to the LCU 130. In response to sensors S, the LCU 130 issues command and control signals that adjust the heat and/or pressure within fusing nip 108 and otherwise generally nominalizes and/or optimizes the operating parameters of finishing assembly 102 (see FIG. 1) for printing multi-channeled layers in an image 158 on a substrate for as print.

Subsequent to transfer of the respective (separation) multilayered images, overlaid in registration, one from each of the respective printing modules M1-M5, the receiver member is advanced to a finishing assembly 102 (shown in FIG. 1) including one or more fusers 170 to optionally fuse the multilayer toner image to the receiver member resulting in a receiver product, also referred to as a final multi-channeled layer print 175. The finishing assembly 118 may include a sensor 172, an energy source 174 and one or more laminators 110. This can be used in conjunction to the registration pattern 155 which is used as a registration reference 176 as well as other references that are used during deposition of each layer of toner, which is laid down relative to one or more registration references, such as a registration pattern. Some example of registration marks include “cross-hairs” placed at the corners of the printed media in addition to those discussed above. The registration marks are required to compensate for machine-to-machine and/or page-to-page image registration errors caused by variability of the paper drive systems. The registration marks are printed along with the original image on a conventional printer using conventional toners. The method for printing registration marks that is machine readable and yet not apparent to a user is to print the registration marks with yellow toner. The registration marks can also be made small and of a fine resolution to further obscure them visually.

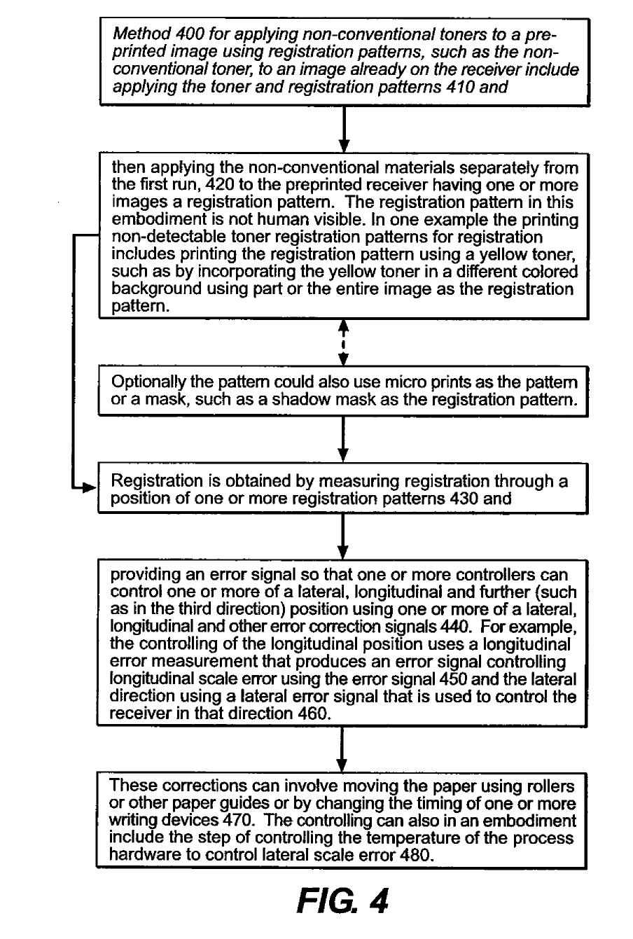

FIG. 4 shows a method of printing a pattern to be used as a registration pattern in order to print with non-conventional materials, such as non-conventional toner, on a preprinted print having one or more images. This method 400 incorporates the printing apparatus described above. The method for applying non-conventional toners to a pre-printed image formed on preprinted media uses registration patterns to register the new materials, such as the non-conventional toner, to an image already on the receiver. The steps include applying the toner and registration patterns 410 and then applying the non-conventional materials, such as toner that are printed separately from the first run, 420 to the preprinted receiver having one or more images a registration pattern using the electrostatic printer that includes the process hardware described above. The registration pattern in this embodiment is machine readable but not human visible. Registration is obtained by measuring registration through a position of one or more registration patterns 430 and providing an error signal so that one or more controllers can control one or more of a lateral, longitudinal and further (such as in the third direction) position using one or more of a lateral, longitudinal and other error correction signals 440, also known and referred to as error signals. For example, the controlling of the longitudinal position uses a longitudinal error measurement that produces an error signal controlling longitudinal scale error using the error signal 450. The control of the lateral direction is obtained using a lateral scale error that can produce a lateral error signal that is used to control the receiver in that direction 460. Please note that these corrections can involve moving the paper using rollers or other paper guides or by changing the timing of one or more writing devices 470.

The controlling steps can include one or more of controlling the lateral position error by controlling receiver position with a receiver guide, controlling the lateral position error by moving the process hardware laterally, controlling the longitudinal position error by synchronizing the action of the process hardware with the longitudinal motion of the receiver. The controlling can also in an embodiment includes the step of controlling the temperature of the process hardware to control lateral scale error 480.

The non conventional toner is applied to a pre-printed image formed on preprinted media by registering patterns on a receiver and includes one or more of clear toner, MICR toner, extended gamut toners, metallic toners, and inks. The non-conventional toners are printed by the same printer or on a separate printer.

In one or more embodiments the methods of printing non-detectable toner registration patterns for registration include printing the registration pattern using a yellow toner, such as by incorporating the yellow toner in a different colored background using part or the entire image as the registration pattern. The pattern could also use micro prints as the pattern or a mask, such as a shadow mask as the registration pattern.

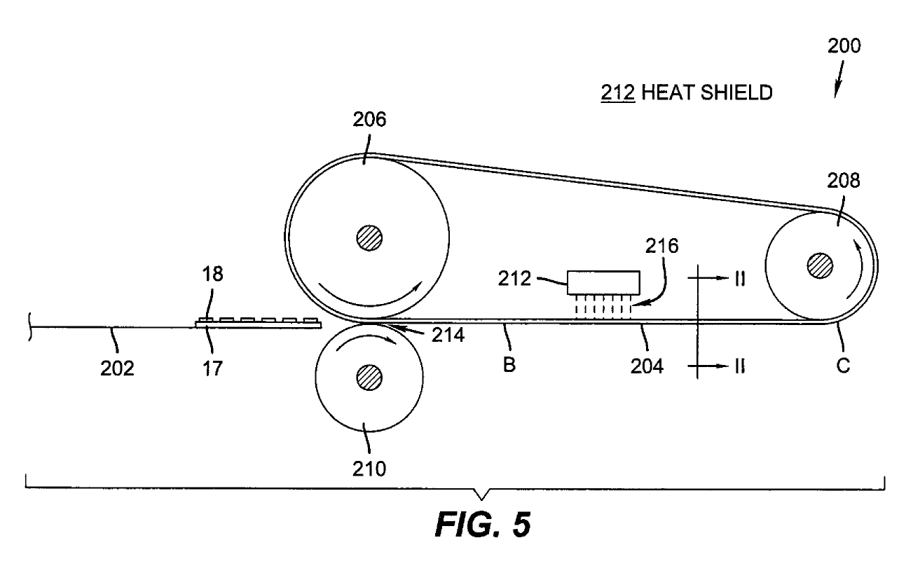

One embodiment of a second printer, sometimes referred to as a finishing assembly, 118 that would allow the top layer to be applied during the fifth module is a type of finishing device 200 shown in FIG. 5. The preprinted item 180, including one or more registration patterns that could be in the image, is transported along a path 202 to the finishing device. The finishing device includes a finishing or fusing belt 204, an optional heated glossing roller 206, a steering roller 208, and a pressure roller 210, as well as a heat shield 212. The fusing belt 204 is entrained about glossing roller 206 and steering roller 208.

The fusing belt 204 includes a release surface of an organic/inorganic glass or polymer of low surface energy, which minimizes adherence of toner to the fusing belt 204. The release surface may be formed of a silsesquioxane, through a sol-gel process, as described for the toner fusing belt disclosed in U.S. Pat. No. 5,778,295, issued on Jul. 7, 1998, in the names of Chen et al. Alternatively, the fusing belt release layer may be a poly (dimethylsiloxane) or a PDMS polymer of low surface energy, see in this regard the disclosure of U.S. Pat. No. 6,567,641, issued on May 20, 2003, in the names of Aslam et al. Pressure roller 210 is opposed to, engages, and forms glossing nip 84 with heated glossing roller 206. Fusing belt 204 and the image bearing receiving member are cooled, such as, for example, by a flow of cooling air, upon exiting the glossing nip 214 in order to reduce offset of the image to the finishing belt 204. Alternately the finishing device could apply a laminate layer 162 and fuse that layer to the final item 160 (see FIG. 3).

The previously disclosed LCU 130 includes a microprocessor and suitable tables and control software which is executable by the LCU 130. The control software is preferably stored in memory associated with the LCU 130.

Sensors associated with the fusing and glossing assemblies provide appropriate signals to the LCU 130 when the finishing device or laminator is integrated with the printing apparatus. In any event, the finishing device or laminator can have separate controls providing control over temperature of the glossing roller and the downstream cooling of the fusing belt and control of glossing nip pressure. In response to the sensors, the LCU 130 issues command and control signals that adjust the heat and/or pressure within fusing nip 108 so as to reduce image artifacts which are attributable to and/or are the result of release fluid disposed upon and/or impregnating a receiver member that is subsequently processed by/through finishing device or laminator 200, and otherwise generally nominalizes and/or optimizes the operating parameters of the finishing assembly 102 for receiver members that are not subsequently processed by/through the finishing device or laminator 200.

Another embodiment for creating a final print 180 includes using a patterned paper (like an embossed paper with a specific pattern) and/or pretreated paper as the registration pattern 155. Alternately a patterned roller could be used on the print prior to application of the top layer, along with a non-contact fusing, using a high MW polymer or high viscosity polymer that would not fuse like regular toner and probably a particle size much smaller than normal toner, also possibly metallic toner particles etc. The regulation of the heat and pressure would be used to control the size and shape of the patterns that would become the registration patterns.

In all of these approaches, a toner may be applied to form the final registration patterns desired. It should be kept in mind that texture information corresponding to the toner image plane need not be binary. In other words, the quantity of clear toner called for, on a pixel by pixel basis, need not only assume either 100% coverage or 0% coverage; it may call for intermediate “gray level” quantities, as well.

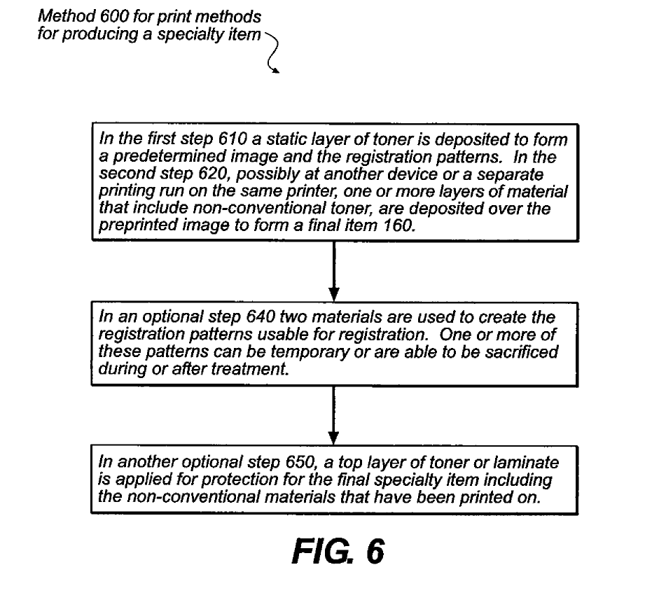

Referring to FIG. 6 we see the flow chart of the method 600 for print methods for producing a specialty item structure. In the first step 610 a static layer of toner is deposited to form a predetermined image and the registration patterns. In the second step 620, possibly at another device or a separate printing run on the same printer, one or more layers of material that include non-conventional toner, are deposited over the preprinted image to form a final item 160. Alternatively a preset registration pattern could be used as discussed above.

In an optional step 640 two materials are used to create the registration patterns usable for registration. One or more of these patterns can be have temporary or are able to be sacrificed during or after treatment. In another optional step 650, a top layer of toner or laminate is applied for protection for the final specialty item including the non-conventional materials that have been printed on the surface of the printed receiver.

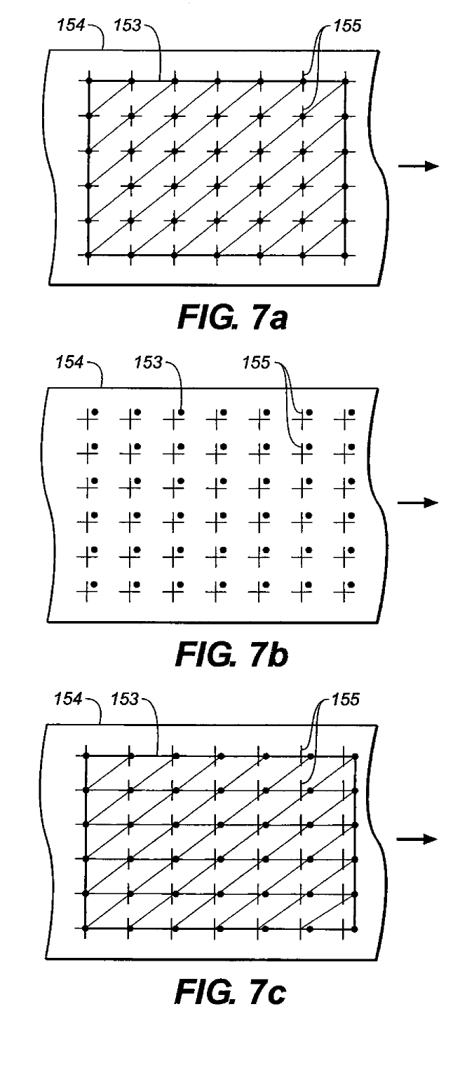

FIG. 7a-c shows some examples of a registration mark that could be used. FIG. 7a shows a simple image shape 153 on the print 154 that incorporates the non-visible registration pattern 155 that is shown as an x for simplicity but would not be visible to a customer due to the simple shape. FIG. 7b shows a simple image shape 153 on the print 154 that incorporates the non-visible registration pattern 155 as a raised shape in clear toner represented by an x for simplicity but would not be visible to a customer due to the fact that the clear toner creates a 3-dimensional shape that is clear and/or of variable gloss that is not obviously visible to the customer. As discussed above, this would not be considered visible since is essentially not noticeable, thus not visible to the unaided eye of the customer although it could be if using touch or other equipment. FIG. 7c shows a combination of the registration patterns shown in FIGS. 7a and 7b including patterns 155 that include an image and the clear toner that creates a 3-dimensional shape that is clear and/or of variable gloss.

In all of these approaches, the materials can be applied as a liquid or as a powder. If the material is applied as a powder then a post fusing will be necessary to remove scattering centers. A preferred embodiment is to apply the polymer as its monomer and polymerize in situ. The initiator for polymerization can be heat sensitive or photosensitive and it will be appreciated that the exact nature will depend on the application and polymer desired.

Capping of the specialty item device is desirable to avoid scratches and other damages which may degrade the usefulness of the specialty item. To accomplish this, the fluid can be capped before or after solidification. If capping is conducted before solidification, lamination is the preferred method as it is simpler to bridge the channels. In this case the lamination must be conducted carefully to prevent gas incorporation of air bubbles, which can act as scattering centers. The capping can also be conducted by depositing particles such as a toner by a process such as electrography or direct blade coating. In this case it would be desirable to have solidified the polymer in the channels such that mixing of the particles and the monomer can not occur. The particles are then fused by heat or solvent to create a uniform non-scattering layer. The capping can also be conducted by coating a liquid by methods well known in the art such as blade or hopper coating. After the coating the capping layer is solidified by drying, crosslinking, or polymerization.

It will be recognized that the capping layer is not necessary for specialty item function. Ai is a very low index material and will act to contain the specialty materials. There may be applications where no capping layer is necessary.

The invention has been described in detail with particular reference to certain preferred embodiments thereof, but it will be understood that variations and modifications can be effected within the spirit and scope of the invention. For example, the electron transporting layer can be a single inorganic layer or an inorganic layer with a underlying organic layer.

What is claimed is:

1. A method for applying non-conventional toners to a pre-printed image formed on preprinted media by registering patterns on a receiver, comprising the steps of:
a. applying an image and a pattern to the receiver using an electrostatic printer including process hardware wherein the pattern is machine readable but not human visible;
b. measuring registration of the pattern and providing an error signal;
c. controlling lateral position error using the error signal;
d. controlling longitudinal position error using the error signal;
e. controlling lateral scale error using the error signal; and
f. controlling longitudinal scale error using the error signal.

2. The method of claim 1 including the step of controlling the lateral position error by controlling receiver position with a receiver guide.

3. The method of claim 1 including the step of controlling the lateral position error by moving the process hardware laterally.

4. The method of claim 1 including the step of controlling the longitudinal position error by synchronizing the action of the process hardware with the longitudinal motion of the receiver.

5. The method of claim 1 including the step of controlling the writer to control one or more of longitudinal and lateral scale error.

6. The method of claim 1 including the step of adjusting the process hardware to control lateral scale error.

7. The method of claim 1 further including applying non-conventional toners to a pre-printed image formed on preprinted media by registering patterns on a receiver.

8. The method of claim 7 wherein the non-conventional toners include one or more of clear toner, MICR toner, extended gamut toners, metallic toners, and inks.

9. The method of claim 8 further including printing the non-conventional toners on a separate printer.

10. The method of claim 1 further including printing the pattern using a yellow toner.

11. The method of claim 10 further including incorporating the yellow toner in a different colored background.

12. The method of claim 1 further including using part or the entire image as the pattern.

13. The method of claim 1 further including using micro prints as the pattern.

14. The method of claim 1 further including a shadow mask as the pattern.

15. The method of claim 1, wherein said pattern comprises one or more indicia.

16. The method of claim 4 wherein said pattern comprises a paper property such as an embossed paper.

17. The method of claim 1, said one or more patterns are temporary so that one or more are sacrificed after registration occurs.

18. The method of claim 1, adding additional information to one or more patterns such that that additional information controls what is printed on a page and enables printing of that page on any printer, in any sequence.

19. The method of claim 18, further digitally changing one or more of said one or more patterns to represent one or more image on that page and treating each page properly using only the registration mark.

20. An apparatus for producing a specialty item, the apparatus comprising:
a. an imaging member;
b. a development station for depositing two or more layers of toner by depositing a static layer of toner to form an image and depositing a second registration pattern over the image, said registration substantially humanly undetectable;
c. an application device to apply a top layer of non-conventional material over said registration pattern, said registration pattern defining an image position relative to the application device; and
d. a controller for controlling the image position relative to the application device during said printing of said bon-conventional material
e. to form a specialty item.

21. The apparatus according to claim 20, said registration pattern further comprising two or more materials.

22. The apparatus according to claim 20, wherein said registration pattern comprises a raised pattern.

23. The apparatus according to claim 20, said one or more patterns further comprising additional information that controls what information is printed on a page so that that page can be printed on any printer, in any sequence.

24. The apparatus according to claim 20, said one or more patterns are digitally changed so each unique registration mark represents that image on that page so that each page has the assigned treatment properly applied using only the registration mark.
